(19) United States
(12) Patent Application Publication
(10) Pub. No.: US 2020/0183992 A1
(43) Pub. Date: Jun. 11, 2020

(54) ONLINE NETWORKING PLATFORM FOR PERSONAL AND PROFESSIONAL RELATIONSHIP MANAGEMENT

(71) Applicant: RJ Garbowicz, St. Petersburg, FL (US)

(72) Inventor: RJ Garbowicz, St. Petersburg, FL (US)

(73) Assignee: Webtalk, Inc., St. Petersburg, FL (US)

(21) Appl. No.: 16/792,293

(22) Filed: Feb. 16, 2020

Related U.S. Application Data
(62) Division of application No. 15/293,093, filed on Oct. 13, 2016.
(60) Provisional application No. 62/241,136, filed on Oct. 13, 2015.

(51) Int. Cl. G06F 16/9535; G06F 16/9537; G06F 16/958; G06F 16/955; G06Q 50/00

(52) U.S. Cl. CPC G06F 16/9535; G06F 16/9537; G06Q 50/01; G06F 16/955; G06F 16/958

(57) ABSTRACT

A networking application provides a platform for users to connect and share information on a personal and professional level. Users connect and are able to define their relationship in a granular and intuitive manner using relationship terms that mimic real-world relationships. These relationships are used to create communication channels between users that dictate permissions for sharing content or posts between users. A user on the network has a newsfeed that shows content that other users are pushing to the user. The user can block posts from users who are in a specific group and sub-group (as defined when the connection between the users was initially created) and can block posts having certain keywords. A user can search his newsfeed using keywords. The user can also search all content on the network (users, organizations, and products) and have the search results ordered based on sentiment trends and weighted rating trends.

### RELATED APPLICATION

This application is a divisional application and claims priority under 35 U.S.C. § 119(e) to U.S. patent application Ser. No. 15/293,093, filed Oct. 13, 2016, entitled “Online Networking Platform For Personal And Professional Relationship Management”, which further claims priority to U.S. provisional application No. 62/241,136, filed Oct. 13, 2015, the contents of which are hereby incorporated by reference.

### FIELD OF THE INVENTION

The present invention relates to software for an online networking application and platform. More specifically, it relates to a network platform for managing connections, posting content, and searching content.

### BACKGROUND

Current online networking applications lack features that enable making and managing connections and relationships with other users efficient and advantageous to those using the network. For example, it would be useful if a user had the ability to precisely label another when making a connection with that user and be provided with intuitive, pre-defined labels that mimic real-life categories of relationships including timeline labels such as “Current”, “Former” and “Prospect” relationships. In addition, such pre-defined labels should be easily selectable when forming the new connection. Online networking applications presently in use do not provide such tools nor do they allow you to write a description with each relationship as you make them on the networking application.

With current networking platforms, users cannot use labels as described above or any other tools to target message and content delivery to specific users. Such platforms lack any type of specific relationship channels that can be used for creating asynchronous permission-based communication and data access channels.

Another drawback of current networking platforms is related to identifying content, whether an article, photo, or video, that is of direct relevance to a user. In current networking platforms there is a proliferation of content posted by users. Sorting through this content and finding a video, picture, digital file, or article that is of high relevance to a user is simply not possible or is too time consuming and inefficient.

Another drawback of other networking platforms is that none offers cash incentive for referrals using any type of software marketing tools. None can grow and be financially viable by motivating users within the network to get revenue.

### SUMMARY

In one aspect of the present invention, methods are described for enabling a registered user of a novel network application to invite new users to the network through various means including email, SMS, and sending links to content that may be of interest to the prospects. The invitations include a trackable link that ensures that if a prospect accepts an invitation and joins the network, the registered user sending the invitation is credited with bringing a new user to the network. When a prospect joins the network, the relationship between the new user and the original user is defined with particularity. The new user defines her relationship with the user who invited her using various pre-defined and intuitive groups and sub-groups of possible relationship types. The same is done by the original user when defining his relationship with the new user. The intuitive and real-life nature of the relationship types facilitates other features of the network platform, specifically with respect to disseminating content to other users.

In another aspect of the present invention, a user is able to perform highly specific and accurate searches for content stored or recorded by users in the network. A user can search on any topic, such as a user, an organization (company, business, service provider, non-profit, etc.), product, or news, using keywords or phrases. The search engine produces a list of search results. Each result is analyzed for sentiment trending through analysis of user comments on each result. Each result is also analyzed for rate trending through analysis of ratings on each result. With respect to rate trending, proximity of the user, both network proximity and physical (geographical) proximity, are taken into account to determine a weight of a particular rating. All these factors are used to derive an overall score for a particular search result in the search list. Finally, an ordered search result list is created based on these overall scores and displayed to the user performing the search.

In another aspect of the present invention, a user can search the user's newsfeed for specific content and can define filters as to what content is posted to the newsfeed. With respect to the filters, a user can block posts from specific groups and sub-groups of connections so that all posts from a particular group of contacts are not posted to the newsfeed. The user can also filter posts that have certain keywords or phrases in the content. With respect to search, the user can search for content in the newsfeed based on keyword searches and post type, such as text only, video, photos, graphics, and the like.

### BRIEF DESCRIPTION OF THE DRAWINGS

The invention and the advantages thereof, may best be understood by reference to the following description taken in conjunction with the accompanying drawings in which:

FIG. 1A is a flow diagram of a process that a registered user of the platform takes to invite non-registered users, referred to as prospects, including individuals, businesses, or other organizations, to join or sign-up with the network platform;

FIG. 1B is a flow diagram of an alternative process of a registered user attracting prospective users to the network in accordance with one embodiment;

FIG. 1C is a flow diagram of a process executed by the system when a new user has entered new user data;

FIG. 2 is a flow diagram of a process of a user posting content on the platform and how the content is disseminated or shared with other users in accordance with one embodiment;

FIG. 3 is a flow diagram of a process of searching a newsfeed using key words in accordance with one embodiment;

FIG. 4 is a flow diagram of a process of performing a search in the networking platform in accordance with one embodiment;

FIG. 5 is a block diagram showing logical and functional components of the network platform's search ranking operation in accordance with one embodiment; and

FIG. 6 is a block diagram showing components of a content viewing device in accordance with one embodiment.

### DETAILED DESCRIPTION

Methods and systems for implementing an online networking platform for creating and managing personal and professional relationships and for content distribution and searching is described. The networking platform enables a user to make connections that are professional and/or personal. It also enables a user to share content, such as reviews, comments, and postings, to manage content and contacts, and perform optimized searches on people, products, services, and organizations.

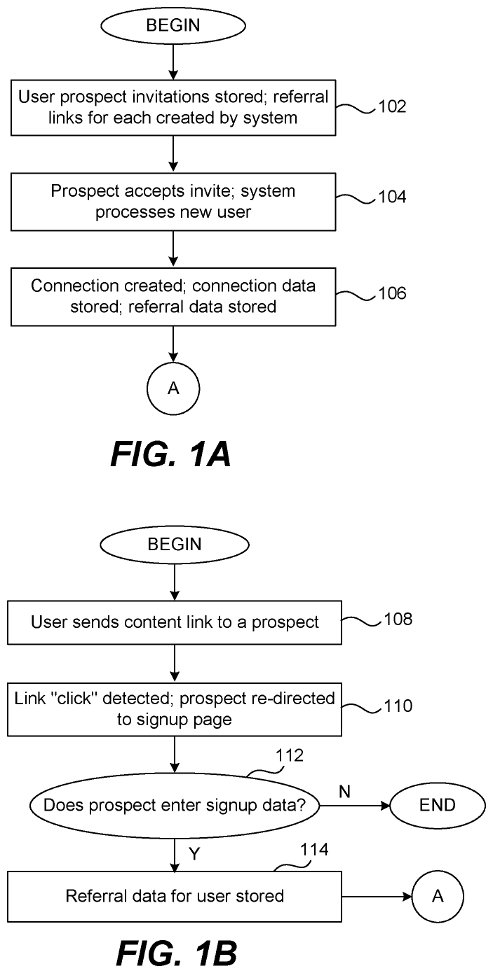

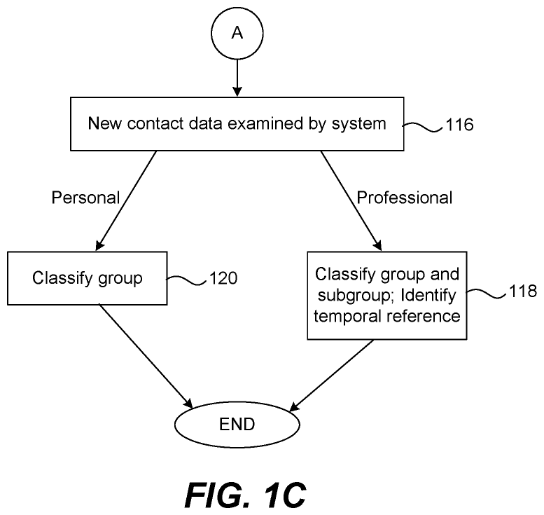

FIG. 1A is a flow diagram of a process that a registered user of the platform takes to invite non-registered users, referred to as prospects, including individuals, businesses, or other organizations, to join or sign-up with the network platform. The user is logged into the network and writes or creates content for the invitation. In this scenario the invitations are sent out via email or short messaging system (SMS). The email addresses and phone numbers are provided by the user and can be imported from external contact management systems, address books, or any source with a suitable API. At step 102 the invitations are stored by the platform or system. In one embodiment, the registered user gets credit for each referral to the network, described below. In order to keep track and monitor the user's referrals to the system and to ensure she is credited by the system, a referral link is created for each invitation. This referral link is created for both SMS and email invitations. These links are embedded in the invitation and are trackable by the platform so that the platform can credit the user with a referral credit if an invitee signs up for the network.

At step 104 a prospect accepts an invitation. That is, the prospect has gone to the landing page of the networking platform as a result of getting the invitation (and clicking on a provisional home page link) and has taken the next step of creating a new account for herself on the network. The prospect has signed up as a new user. The system processes all the new user information and creates an account for the user. At step 106 the platform or system creates a connection between the user and the prospect, now a new user. One component of the information provided by the user and the prospect is relationship data. That is, in what capacity does the user know the prospect (new user) and what is the nature of the reverse relationship, that is, how does the new user know the user. It is important to note that they may not be the same. One may be a service provider/vendor and the other may be client/customer. There may also be more than one type of relationship: a user may be a service provider or vendor but may also be classified as a personal friend or family member, to name one example out of many In addition, referral data for the user is also stored or recorded to ensure that the prospect was created through referral of a registered user.

FIG. 1B is a flow diagram of an alternative process of a registered user attracting prospective users to the network in accordance with one embodiment. In this scenario, a user attracts an individual prospect (or, for example, a small group of related prospects) to the network by sharing content (network or Internet) that the user believes will be of interest to the prospect. In one embodiment, the content is available only to those registered with the network platform.

At step 108 the user sends a link (to the content) to a prospect via email or SMS. The user may provide a short description of the content to get the attention or interest of the prospect and mention that the prospect can see all the content if she decides to join the network. In this embodiment, a trackable link also exists within the email or SMS to locate the registered user who sent the invitation. In another embodiment, the prospect can view a portion of the content and learn about the network first without being required to join the platform. At step 110 the prospect activates (clicks) the link and the system re-directs the prospect to the network platform sign-up page. At step 112 the system determines whether the prospect starts the sign-up process by determining whether data is being entered. If the prospect does so, control goes to step 114. It is assumed at this stage that the prospect is signing up for the network, and referral data is stored in the system so that the user is credited with a referral. If the prospect declines to proceed with the sign-up, the process ends.

FIG. 1C is a flow diagram of a process executed by the system when a new user has entered new user data. It takes place after step 114 or step 106. At step 116 new user data (the contact data) is examined by the system. In one embodiment, the first analysis performed is of the nature of the relationship from the perspective of the new user, between the new user and the user who invited her to the system. If the new user classifies her relationship with the registered user as personal, control goes to step 120. If she views the relationship as professional, control goes to step 118. As noted, the new user may classify the registered user as both a personal and professional relationship.

At step 118, the professional contact selection is further classified into a group and a sub-group, as described below. A temporal reference is also included for certain sub-groups, that is, whether the nature of the relationship is current, from the past, or a prospective (future) relationship. At step 120 the personal relationship is also classified into a group. The new contact data also includes data entered by the registered user about the prospect. That is, from the perspective of the registered user. Once the prospect accepts an invitation (whether through the process in FIG. 1A or 1B), the registered user enters information about his connection with the prospect/new user. Specifically, he enters data about the nature of the relationship with the new user, similar to steps 116-120. As noted, the nature of the relationship may be different from the perspective of the registered user compared to that of the prospect, although in many cases the relationship will likely be the same.

It is important to note that the classification of relationships, whether personal or professional, what type of professional relationship, and the temporal factor of the relationship, are utilized by other tools and features of the networking platform. It is also useful to note here that one of the dynamic factors is the number of contacts and how a registered user connects with these new users. This includes users connecting with not only prospects who have signed onto the network, but also with other registered users. These relationships are used as designations or permission/sharing settings, also referred to as channels.

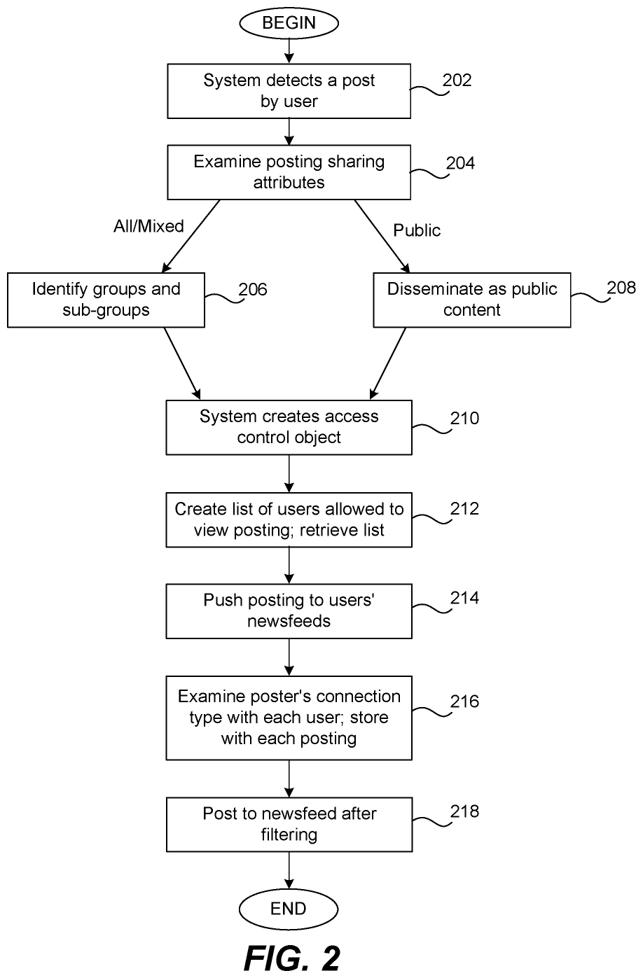

FIG. 2 is a flow diagram of a process of a user posting content on the platform and how the content is disseminated or shared with other users in accordance with one embodiment. At step 202 the user posts content to the platform, which may be comprised of only text or text with multimedia, such as photos, videos, graphics or other type of content. The system detects that the user has made this post. The user provides sharing attributes for the post, as to which groups and sub-groups, the user wants to share the post with.

At step 204 the system examines the sharing attributes of the post. If the post can be shared with everyone in the network or with a “mixed” group of connections, such as only current professional connections or only personal relationships which are classified as friends, among many other examples and variations. If the content is classified as sharable with all of the user's groups and sub-groups or a limited number of groups and sub-groups, control goes to step 206, referred to as the “All/Mixed” option indicating all groups or a subset thereof. At step 206, the actual groups and sub-groups that the user wants to share the content with are identified. If the user wants to share the content with everyone, including all users on the network and beyond (i.e., with all Internet users), control goes to step 208, indicated by the “public” branch from step 204.

At step 208 the content is made available to everyone by making it visible on the user's home page on the platform that can be viewed by anyone on the Internet visiting the user's profile (unrestricted).

Now that the permissions for sharing the content have been defined and set by the user, control goes to step 210 where the platform or system creates an access control object. In one embodiment, this control object provides a detailed description of who can see the content (e.g., text, photo, video, or combinations). It controls access to the content so that even someone with a direct link to the content will not be able to view it if permission to the user with the link is not indicated or defined in the access control object.

At step 212 the system creates a list of users allowed to see the content or post, unless the content is public. The list is created based on the users included in the poster's connections in the groups and sub-groups indicated above. The list of users belonging to the said groups and sub-groups is retrieved. At step 214 the system pushes the content to the newsfeeds of all the users on the list. As described in the next steps, this does not necessarily imply that the content will automatically be posted to those users' newsfeed; it is pushed to those users and made available for posting in their newsfeeds only if there are no filters, as described below.

At step 216 the system examines the poster's (the user posting the content) connection type with each user in the list created at step 212. For example, the poster may be a customer or client of a user on the list. That is the nature of the relationship from the poster's perspective. This can be characterized as a one-sided channel of communication, a client channel, from the poster to the user (recipient) where a channel has a set of permissions associated with it. The nature of the user's relationship with the poster is vendor or service provider. That is the one-sided channel of communication that the user has with the poster. As noted above, the channel of communication between a poster and a user may often be the same, such as former colleague, current classmate, or family member. In these cases, the nature of the relationship between the two users is the same and so the channel of communication between them, while one-sided from the perspective of each user, is also the same. Returning to step 216, the poster's connection type with a user is stored with the specific posting.

At step 218, the system applies filters set up by each of the users in the list to the posting. For example, the post is pushed to a user's newsfeed from the poster as described above. The poster is a vendor to the user, so it can be described as a vendor channel. The user may have defined a filter that blocks posts of any content from a vendor to the user's newsfeed. As such, the content will not be posted to the user's newsfeed. In another example, the poster may be a former classmate of the user. The user may have defined a filter for former classmates intending that all postings from that sub-group should be blocked from appearing on that user's newsfeed. In another example of a filter not associated with groups and sub-groups, a user can block all postings having certain words or phrases from appearing in the user's newsfeed. For example, a user may not want any postings or content related to politics in her newsfeed, so she can enter keyword filters, such as “politics”, “campaign”, “Clinton”, “Trump, and the like, to block political postings. As can be seen, there are many examples of filters that can be applied. If there are no filters blocking the content from the newsfeed for a particular user, the post appears in that user's newsfeed at step 218 at which stage the process ends.

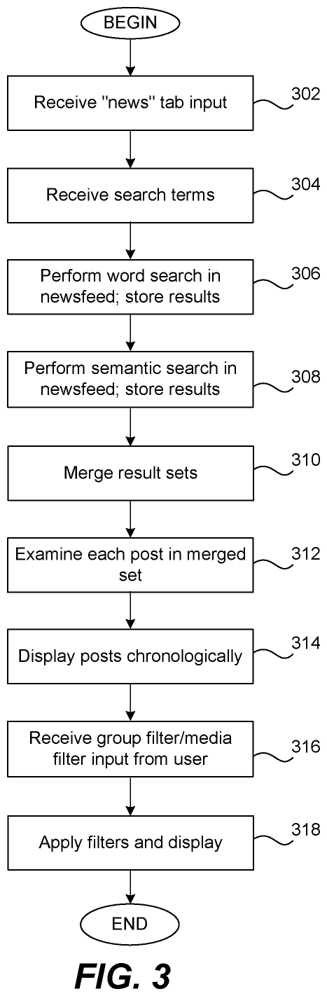

FIG. 3 is a flow diagram of a process of searching a newsfeed using key words in accordance with one embodiment. In the networking platform of the present invention, a user can search her newsfeed for postings relevant to the search terms. Given the huge volume of postings, user-generated content, comments, media, and the like with current network platforms, being able to perform a search in the user's newsfeed to identify specific content that is relevant to a topic of interest to the user is a very advantageous feature of the present networking platform.

At step 302, the user has selected the “News” tab in her profile. By selecting this tab, the user is telling the system that she wants to view her newsfeed. The system receives the “News” tab input and the user's newsfeed is displayed. At step 304 the user has typed in one or more search terms into a search window associated with the newsfeed. As noted, the volume of postings may be large and the user wants to identify only postings relating to a particular topic. The system receives the search terms as input.

At step 306 the system performs a word search in the newsfeed based on the search terms (keywords). The system performs the search and stores the search results but has not displayed them. At step 308 the system performs what is referred to as a semantic search based on the search terms. The search terms are interpreted using a semantic or data dictionary to see if equivalent terms exist that can be used to perform the search. In this manner, search terms that have semantic equivalents, can be used to perform the search. For example, a user may search using the phrase “Use of European tax code in America.” While a search will be performed using this phrase under the word search operation of step 306, the system may perform a semantic search using the phrase “Use of European tax law in the United States.” If the data dictionary finds a semantic equivalent of any words used in the original search, those semantic equivalents are used in a search as well at step 308. The system stores the results of the semantic search. At step 310 the search results from the two searches are merged. Any duplicate search result entries are deleted. At step 312 the system examines each post in the merged list. Specifically, the comments, “likes/dislikes,” and other content related to the sentiment of the post, are examined. At step 312 the system displays the posts in chronological order. The most recent post may be at the top. In one embodiment, the user can click on an icon associated with the post to see the poster's relationship to the user.

In another embodiment, the user may want to filter the posts. That is, of the post that resulted from the keyword search by the user, the user may apply a filter to further narrow the results. In one embodiment, there are two types of filters. One is a group filter where the user can specify whether she wants to see only posts from the professional side of her network or only from the personal side. She can also specify sub-group filters, such as only posts from current colleagues or from current clients/customers. All other posts are filtered out. There are many variations on how the group and sub-group filters can be applied to further focus the posts to the user's interest. Another type of filter is a media filter. As noted, posts can be comprised of text only, photograph, video, graphics, and combinations thereof. The user can filter the search results so that only text posts appear in the search results or only posts with text and/or pictures. This is another way for a user to fine tune the search with a degree of granularity that is not available in other networking platforms. These filters are received by the system as user input at step 316. The filters are then applied to the search results and the filtered search results are displayed at step 318.

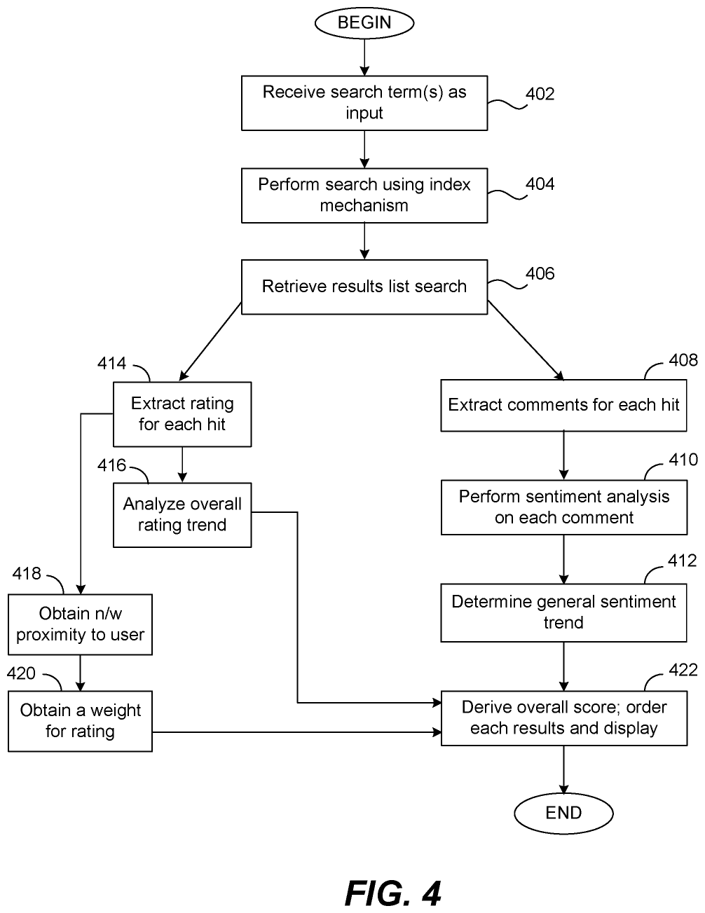

FIG. 4 is a flow diagram of a process of performing a search in the networking platform in accordance with one embodiment. At step 402 the user types in one or more search terms in a search entry box. The system receives these search terms as input. At step 404 a search engine using an indexing mechanism performs a search using the terms entered at step 402. All content that is posted in the network is indexed immediately using a fast indexing system. The system uses word stemming to locate the word roots in order to define equivalency of search terms. Furthermore, fuzzy search capabilities are applied to locate close matches, instead of exact matches. A user can configure these options in order to get the type of results they require. The system examines all the user-generated content in the network. This includes all content relating to users (individuals), companies/organizations, services, and products, and other entities. The search performed is a semantic search as well as a text-based search. In one embodiment, early results of the search may be displayed as the user types in multiple search terms.

At step 406, the system retrieves an ordered list of search results. At this stage, two or more processes occur concurrently. A search result, for example, a product or a service, may have comments associated with it from other users. For each search result in the list, the system extracts comments for that posting or content. These comments are extracted at step 408 so that only the actual text of the search result remains. Similarly, at step 414, the rating for the search result, is also extracted. A rating can be a simple number of stars or other numeric value.

Following the line of operations at step 408, after the comments are extracted, at step 410 the system performs what is referred to as sentiment analysis for the extracted comment. In one embodiment, this involves natural language processing and uses a logistic regression classifier engine to see how fast and to what degree sentiment on that item is positively or negatively regressing. Here sentiment analysis is performed on a single comment at a time. At step 412 the system determines a general, overall sentiment trend for that search result. For example, are users liking or disliking a particular product or service provider, and how quickly is the like/dislike trending. Is the product or service provider rising in popularity or decreasing for some reason? Sentiment analysis at step 408 and 410 can provide a granular rating for the product, service, user, or company/organization. The system analyzes the overall sentiment by aggregating the individual sentiment numbers from each comment. This is done for each hit in the search result list.

Returning to step 414, after the rating for the item is extracted, two lines of operation are performed. At step 416 the system examines the overall rating trend for that search result. It determines whether the rating for that item is going up, down, or staying level. At the same time, once a rating is extracted for a hit at step 414, control goes to step 418 where the system obtains a network proximity value between the user who posted the rating and the user performing the search. The system determines how many degrees of separation or number of connection exist between the user who provided the rating and the user doing the search. For example, a direct connection has a value of 1, if the rater is a direct connection of one of the searcher's direct connections, it has a value of 2, and so on. This proximity determination may be done for connections up to n degrees of separation, where n can be selected by the platform manager. At step 420 the system uses the number of connections between the rater and the searcher to calculate a weight of the rating, to derive a proximity-based weighed rating. If the proximity is greater than n connections, the weight of the rating is zero or not considered. The principle here is that the closer the rater is to the searcher, the more meaningful the rating is to the searcher. A rating given by a direct connection of the user doing the search means more or is more relevant to the searcher than a rating given by a user three or four degrees of separation from the searcher.

At step 422 the system takes input from the processes described above and derives an overall score for the specific product, service, user, or organization in the search result list that is being examined. As shown in the figure, there is input from three sources: general sentiment trend from analyzing the comments for that item, an overall rating trend for that item, and a rating weight based on network proximity of the rater. These three data items are aggregated or combined using a formula to derive an overall score. Each item on the list is given an overall score and the list is then ordered based on the score. In one embodiment, the item with the highest overall score is at the top of the list and the lowest scoring item is at the bottom. The list is then displayed to the user as the final search result. In this manner, the user doing the search (step 402) is given a highly relevant and granular search result list based on overall sentiment for each item in the list, overall ratings, and the relevancy of those ratings to the user.

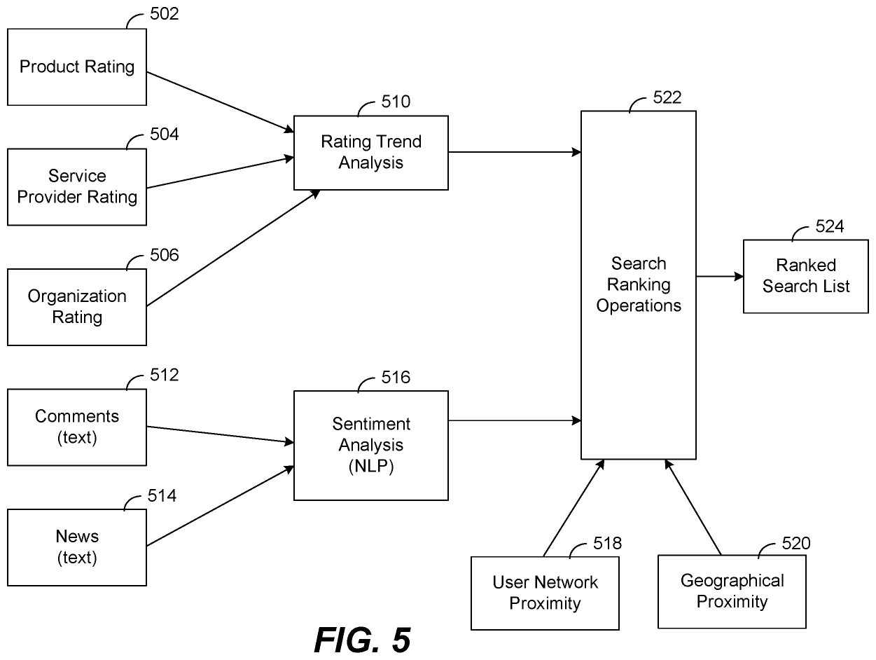

FIG. 5 is a block diagram showing logical and functional components of the network platform's search ranking operation in accordance with one embodiment. It shows software modules and data sets used in the news feed searching process, much of which has been described above. One of the categories of data that is analyzed is the ratings: product ratings 502, service provider ratings 504, and organization rating 506 (companies, partnerships, government agencies, and so on). These ratings, which can be a numeric value or star rating type data, are input to a rating trend analysis module 510.

Separately, text-based comments associated with a posting, if any, are identified by comments module 512. Any news items associated with the posting are identified at module 514. News-based sentiment analysis capability allows a user to track the public sentiment about a specific topic of interest. All news related to specific keywords is passed through the sentiment engine to determine how the public perceives it over time. These two data types—comments and news—are input to a sentiment analysis module 516 which, in one embodiment uses NLP, to determine an overall sentiment about the posting. Sentiment determination (output from module 516) and ratings trend data for the posting are input to a search ranking operations module 522. Other data that is input to module 522 is user network proximity 518. As described above, this is a value indicating how many connections away the user making the posting is from the user performing the search. As a general guideline, the user performing the search will trust postings from a user who is close to her in the network (e.g., one or two connections away). Another input to ranking operations module 522 is geographical proximity 520 of the user making the post. Similarly, users who are geographically close to the user doing the search may have more relevant or useful content to share, depending on the nature or type of search.

Search ranking operations module 522 outputs a ranked search list 524 that is displayed to the user. The one or more algorithms implemented in module 522 assign relative weights to each value—ratings, sentiment, and proximity—in order to derive a final score. For example, default weights of 3, 2, and 5 may be assigned to the three values which can serve as linear multipliers to get an overall score. These weights can be adjusted to different values, which allows users to treat, for example, proximity, in a more favorable light. User distance (or other values associated with ratings and sentiment) can serve as a linear multiplier (in the proximity example, based on their network or physical distance), or it can be a logarithmic multiplier, which affects the weight, but not as much. As noted, the user may apply group and/or media filters to the list to further narrow the number of postings.

In another aspect of the present invention, an affiliate compensation plan enables growth of the network and revenue for users, in addition to the side benefit of greater content sharing. In one embodiment of the compensation plan, there are three classifications of users: regular (or recreational) users, affiliate users, and team trainers. It is also helpful to note that there are two types of memberships, free (non-premium) and premium. One of the goals of the plan is to increase membership. The network provides incentives to users to bring in new members. In one embodiment, a user enrolls to become an affiliate. This involves an agreement with the network reciting terms and giving the user permission to enroll as an affiliate. As described below, affiliate users drive more users to the network and non-affiliate users are essentially recreational users.

As an affiliate, in one embodiment, the user gets 10% of the ad revenue brought in by new members that the affiliate recruits/refers to the network, described as “10% revenue share on all advertising and subscription sales.” If an affiliate brings in 50 new users, she gets 10% of the ad revenue stemming from those users. In one scenario, all the users recruited are non-premium users. The availability of viral social media tools in the network app, and the linking of them to the affiliate plan are described below. The network provides further incentive to the affiliate to earn additional revenue. If the affiliate converts any of the free users she has recruited/referred to a premium membership (e.g., where the user pays a monthly subscription fee for enhanced and exclusive services and tools), the compensation plan in Step 2 is triggered. At this stage, the affiliate has become a team trainer. These different levels of user may be characterized as qualifications for compensation.

When one user brought in by an affiliate upgrades to a premium user, the affiliate can earn 10% from all users brought in by the recruited user down to five levels (four additional levels added to the default first level for recruiting/referrals), referred to as referral levels. As such, the earning potential (revenue sharing potential) of the affiliate, now team trainer, increases significantly. The network application facilitates the affiliate compensation plan by providing social media marketing tools to the users. These viral tools include SMS and Email, specific buttons, banners, and shared media, and are intended to assist with inviting friends, colleagues, and others to connect with an affiliate user. All these social media tools have trackable links which assist with keeping track of which members joined the network and through which affiliate, among providing other detailed data on how new members are driven to the network. Affiliate users can also share social media files, videos, and other content to entice or motivate people to join and connect with you on the network.

An entirely new product brand for the affiliate program behind the networking community software was created to allow for two types of online sales process; a hard sell and a soft sell, described above in FIGS. 1A and 1B. Users who join the networking community software are considered customers. The affiliate software was created to turn the networking community users/customers into independent online marketers by being more engaging within the networking community, through uploading content and sharing it on the Internet/inviting friends to connect on the network using built in email and SMS invitation tools, and posting social media buttons and banner ads on websites. On average, only five percent of users on other social networks invite their contacts; this proprietary process increased that percentage to 90% during a pilot test launch.

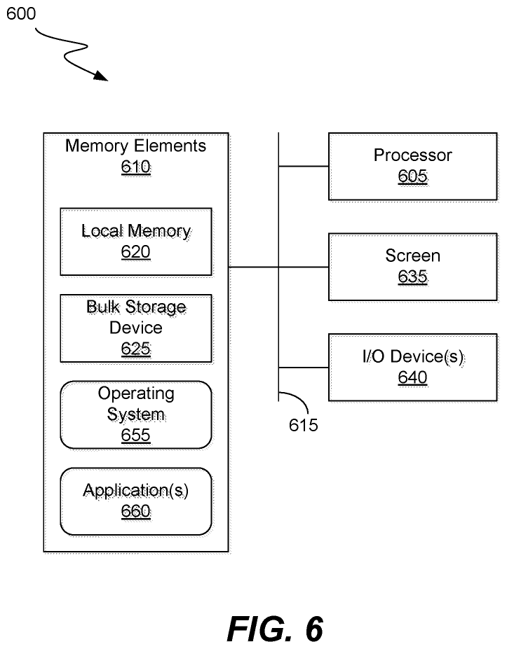

FIG. 6 is a block diagram of a data processing system 600 in accordance with one embodiment. System 600 may be used to implement any of a variety of systems and/or computing devices that include a processor and memory and that are capable of performing the operations described within this disclosure. In one embodiment, it can be used to implement a smart watch or phone. It can also be used to execute computer instructions to implement the logic flowcharts in FIGS. 2 and 4. The device may be any device described in connection with FIGS. 1-4.

As pictured, system 600 includes at least one processor 605 coupled to memory elements 610 through a system bus 615 or other suitable circuitry such as an input/output (I/O) subsystem. System 600 stores program code within memory elements 610. Processor 605 executes the program code accessed from memory elements 610 via system bus 615. Memory elements 610 include one or more physical memory devices such as, for example, a local memory 620 and one or more bulk storage devices 625. Local memory 620 refers to random access memory (RAM) or other non-persistent memory device(s) generally used during actual execution of the program code. Bulk storage device 625 may be implemented as a hard disk drive (HDD), solid state drive (SSD), or other persistent data storage device. System 600 may also include one or more cache memories (not shown) that provide temporary storage of at least some program code in order to reduce the number of times program code must be retrieved from bulk storage device 625 during execution.

System 600 may be coupled to one or more I/O devices such as a screen 635 and one or more additional I/O device(s) 640. The I/O devices described herein may be coupled to system 600 either directly or through intervening I/O controllers. In one aspect, screen 635 may be implemented as a display device that is not touch sensitive. In another aspect, screen 635 may be implemented as a display device that is touch sensitive.

Examples of I/O device(s) 640 may include, but are not limited to, a universal remote control device, a keyboard, a mobile device, a pointing device, a controller, a camera, a speaker, and a microphone. In some cases, one or more of the I/O device(s) may be combined as in the case where a touch sensitive display device (e.g., a touchscreen) is used as screen 635. In that case, screen 635 may also implement a keyboard and a pointing device. Other examples of I/O devices 640 may include sensors. Exemplary sensors may include, but are not limited to, an accelerometer, a light sensor, touch screen sensors, one or more biometric sensors, a gyroscope, a compass, or the like.

I/O devices 640 may also include one or more network adapter(s). A network adapter is a communication circuit configured to establish wired and/or wireless communication links with other devices. The communication links may be established over a network or as peer-to-peer communication links. Accordingly, network adapters enable system 600 to become coupled to other systems, computer systems, remote printers, and/or remote storage devices, such as remote servers storing content. Examples of network adapter(s) may include, but are not limited to, modems, cable modems, Ethernet cards, wireless transceivers, whether short and/or long range wireless transceivers (e.g., cellular transceivers, 802.11x (Wi-Fi™) compatible transceivers, Bluetooth® compatible transceivers, and the like).

As pictured in FIG. 6, memory elements 610 may store an operating system 655 and one or more application(s) 660, such as applications for translating symbols and zero-amplitude time durations and symbol mapping tables. It may also store software for segmenting or breaking a message (to be transmitted) into pieces or segments that can be represented by symbols. In one aspect, operating system 655 and application(s) 660, being implemented in the form of executable program code, are executed by system 600 and, more particularly, by processor 605. As such, operating system 655 and application(s) 660 may be considered an integrated part of system 600. Operating system 655, application(s) 660, and any data items used, generated, and/or operated upon by system 600 are functional data structures that impart functionality when employed as part of system 600.

As noted, in one aspect, system 600 may be used to implement a smart phone, smart watch, or other type of wearable device. In another aspect, system 600 may be used to implement a computer, such as a personal computer, a server, or the like. Other examples of mobile computing devices may include, but are not limited to, a tablet computer, a mobile media device, a game console, a mobile internet device (MID), a laptop computer, a mobile appliance device, or the like.

System 600 may include fewer components than shown or additional components not illustrated in FIG. 6 depending upon the particular type of device that is implemented. In addition, the particular operating system and/or application(s) included may also vary according to device type as may the types of network adapter(s) included. Further, one or more of the illustrative components may be incorporated into, or otherwise form a portion of, another component. For example, a processor may include at least some memory.

Various embodiments described herein involve distinct features. It should be appreciated that any feature or functionality from one figure or embodiment may be incorporated into any other figure or embodiment.

Although only a few embodiments of the invention have been described in detail, it should be appreciated that the invention may be implemented in many other forms without departing from the spirit or scope of the invention. It should be appreciated that in some embodiments, one or more of the steps in the methods may be modified, reordered and/or deleted. Therefore, the present embodiments should be considered illustrative and not restrictive and the invention is not to be limited to the details given herein.

What is claimed is:

1. A method of searching a user newsfeed in a network application, the method comprising:
receiving as input search terms for performing a search;
executing a first search of the newsfeed using the search terms and an indexing mechanism, resulting in a first search result set;
executing a second search of the newsfeed using a semantic process including a semantic data dictionary, resulting in a second search result set;
merging the first search result set and the second search result set to create a final result set; and
filtering the final result set based on group and sub-group filtering and topic filtering.
